(19) United States
(12) Patent Application Publication
(10) Pub. No.: US 2016/0073228 A1
(43) Pub. Date: Mar. 10, 2016

(54) SYSTEM AND METHOD FOR GENERATING EXPECTED GEOLOCATIONS OF MOBILE COMPUTING DEVICES

(71) Applicant: MASTERCARD INTERNATIONAL INCORPORATED, Purchase, NY (US)

(72) Inventor: Justin X. Howe, Oakdale, NY (US)

(73) Assignee: MASTERCARD INTERNATIONAL INCORPORATED, Purchase, NY (US)

(21) Appl. No.: 14/477,388

(22) Filed: Sep. 4, 2014

(51) Int. Cl. H04W 4/02; G06Q 10/08

(52) U.S. Cl. CPC H04W 4/021; H04W 4/028; G06Q 10/083

(57) ABSTRACT

A computer-implemented method for generating a geographical information database associating users with one or more geolocations. The method includes the steps of receiving user identification data, geolocation data, and date and time data associated with the geolocation data from the personal computing devices of a plurality of users. The data is normalized into a predetermined format, and stored in the database. The method further includes periodically requesting updated geolocation data, and date and time data associated with the updated geolocation data from the personal computing devices of the plurality of users.

### CROSS-REFERENCE TO RELATED APPLICATIONS

None.

### FIELD OF INVENTION

The present disclosure relates to systems and methods for generating a database of geographical information associated with a plurality of individuals or entities. More particularly, the disclosure relates to systems and methods for generating a geographical information database associating a plurality of individuals or entities with geolocation data acquired through their personal computing devices.

### BACKGROUND

In an increasingly global economy, a significant issue facing consumers, merchants, and credit providers includes establishing reliable systems for facilitating the physical delivery of information and goods to individuals or entities. This is particularly problematic in geographic areas lacking standardized mailing addresses. More specifically, in many countries the process of delivering mail or other packages relies heavily on non-standardized and often inaccurate descriptions of a location (e.g. a residence) of a receiving party. For example, an individual ordering an item via online purchase may be able to identify themselves as residing in a particular city or town of a country, but does not have a formal street address to provide for facilitating delivery of the good. It may be customary for the individual to describe their location in some informal manner, such as its relationship to a popular landmark (e.g. across the street from a commercial establishment). As a result, successful delivery of information or goods is often dependent on the local knowledge of a carrier, or other informal practices such as word of mouth, to aid in locating a particular individual or entity.

Geocoding techniques have been implemented to create a standardized geographic information protocol. As will be understood by one of ordinary skill in the art, geocoding is the process of determining geographic coordinates or geolocations (often expressed as latitude and longitude coordinates) from other geographic data, such as street addresses, or postal codes. Using these geolocations, relevant data points (e.g. landmarks, residences, businesses, etc.) can be mapped and entered into geographic information systems or databases, wherein the data may be accessed and utilized by a variety of service providers or other interested parties. However geocoders, or software-based applications for performing geocoding, generally rely on standardized address formatting in order to generate a corresponding geolocation. Accordingly, geocoding cannot be effectively implemented into regions where standardized addresses do not exist. As such, geographical information systems or databases are unable to be widely populated with relevant data relating to, for example, individuals, entities, or places of interest located in these regions.

Alternative systems and methods for reliably identifying or associating a geographical location with individuals, entities or places of interest are desired.

### SUMMARY

In one embodiment of the present disclosure, a computer-implemented method for gathering geolocation data from a personal computing device is provided. The method includes the steps of receiving, from a user, identification data and address description data entered into the personal computing device. The geolocation of the personal computing device is determined or captured, along with a date and time associated with the determination of the geolocation. The user identification and address description data, and the geolocation and associated date and time data is then transmitted to a remote server for storage and future processing. The steps of determining the geolocation of the personal computing device and the associated date and time, as well as the transmissions of this data to the remote server may be repeated at a predetermined interval or desired time.

In another embodiment, a computer-implemented method for generating a geographical information database associating users with one or more geolocations of their personal computing devices is provided. The method includes the steps of receiving user identification data, geolocation data, and date and time data associated with the geolocation data from the personal computing devices of a plurality of users. The data is normalized in a predetermined format and stored in the database. The method further includes periodically requesting updated geolocation data, and date and time data associated with the updated geolocation data from the personal computing devices of the plurality of users.

A computer-implemented method for generating an expected geolocation of an individual in response to a request is also provided. The method includes receiving a request for geolocation data associated with a personal computing device of an identified individual according to at least one temporal or geographical characteristic, such as a future date and time or a non-standardized address description. Geolocation data associated with the personal computing device of the identified individual is located within a database comprising data associating the geolocations of a plurality of personal computing devices with a plurality of individuals. The data may be analyzed according to the at least one characteristic in order to predict or generate an expected geolocation of the individual. For example, wherein the at least one characteristic is an estimated future time or date, and the step of analyzing the identified data may include performing a historical analysis of the identified data for predicting the geolocation of the individual at or around the estimated future time or date. Likewise, if the at least one characteristic is a non-standardized address description, and the step of analyzing the identified data may include performing comparative analysis to identify a geolocation associated with a similar stored non-standardized address description.

### BRIEF DESCRIPTION OF THE DRAWINGS

FIG. 1 illustrates a system architecture within which some embodiments of the present disclosure may be implemented.

FIG. 2 is a functional block diagram of a managing computer system in accordance with an exemplary embodiment of the present disclosure.

FIG. 3 illustrates a process flow diagram of an exemplary process of acquiring participant identification data and associated geolocation data via a participant mobile computing device according to an embodiment of the present disclosure.

FIG. 4 illustrates a process flow diagram of an exemplary process for receiving participant identification data and associated geolocation data by a managing computer system according to an embodiment of the present disclosure.

FIG. 5 illustrates a process flow diagram of an exemplary process for generating a geographical information database using identification and geolocation data associated with a plurality of participants according to an embodiment of the present disclosure.

FIG. 6 illustrates a process flow diagram of an exemplary process for determining a predicted or expected geolocation of an identified participant according to an embodiment of the present disclosure.

FIG. 7 illustrates a data flow diagram for determining a predicted or expected geolocation of an identified participant according to an embodiment of the present disclosure.

### DETAILED DESCRIPTION

It is to be understood that the figures and descriptions of the present disclosure have been simplified to illustrate elements that are relevant for a clear understanding of the embodiments described herein, while eliminating, for purposes of clarity, many other elements found in computing systems and wireless communication devices, such as mobile telephones or smartphones communicating with one or more remote computers or servers via a local, internet, cellular or satellite networks, as well as computer systems or mobile telephones running native or web-based applications or other software. However, because such elements are well known in the art, and because they do not facilitate a better understanding of the present invention, a discussion of such elements is not provided herein. The disclosure herein is directed to all such variations and modifications known to those skilled in the art.

As used herein, the term “processor” broadly refers to and is not limited to a single- or multi-core general purpose processor, a special purpose processor, a conventional processor, a Graphics Processing Unit (GPU), an Applications Processing Unit (APU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As set forth above, many geographical regions (including entire countries) have not implemented standardized address formatting. For example, in countries such as India, residencies and places of business may be associated with a discrete and identifiable postal code, city or town, however, may not be identified by more specific address identifiers (e.g. street names, building numbers, etc.). Common practices for more specifically identifying a particular location within these regions include natural language address descriptions utilizing, for example, landmarks and the like as reference points. In view of the non-standard nature of these address or location identifiers, typical geocoding operations are unable to be performed. As a result, these locations can not readily be incorporated into existing geographical information databases utilized by various service provides (e.g. mail carriers and other parcel delivery services).

Disclosed herein are processor-executable methods, computing systems, and related processing for generating a geographical information database associating a plurality of individuals or entities with geolocation data acquired through their personal mobile computing devices. In one embodiment, a participant (e.g. an individual or entity) may download executable program code for a software-based application onto their personal computing device, for example, their mobile phone. Once launched, the application may be configured to cause a processor of the personal computing device to prompt the participant to enter identification information, such as their first and last name. The application may also prompt the participant to enter any available address information for a residence, business or other location of the participant. This may include standardized or non-standardized address descriptions, or combinations thereof. For example, a participant residing in a region that does not utilize standardized addresses, but utilizes postal codes, may enter the postal code, as well as any descriptive terms the participant normally uses to identify their place of residence (e.g. above the Laundromat) or other location (e.g. their place of business) they wish to associate with accessible geographical data. Information entered by the participant, as well as the date and time at which they were entered, may be stored by the participant device (e.g. in a memory device of the mobile phone).

The application is further configured to generate geolocation data based on the location of the participant device. In one embodiment, this step may include interfacing with the device's on-board global positioning system (GPS) and determining its geolocation (e.g. in the form of latitude and longitude coordinates). The step of generating geolocation data may be done automatically, for example, after entry of the above-described participant data, or done in response to a participant input. For example, a participant may input an address description corresponding to their place of residence into their device. Once input, the participant may prompt the application to generate geolocation data at a time when they are present in that location.

In one embodiment, the date and time associated with the generation of geolocation information may be stored into the memory of the participant's device along with the geolocation information. The application may be further configured to automatically, or upon a participant command, transmit the generated geolocation data, participant identification data, address data (if available) and date and time data to a remote server or management computer via, for example, a wireless network such as a cellular phone data network and/or the internet. The phone number of the participant device may also be transmitted.

In another embodiment, the application may be configured to continuously and/or periodically generate geolocation data associated with the participant device. For example, the application may be configured to continuously repeat the steps of generating geolocation data and storing the date and time of the generation, as well as the transmission of said data to the remote server. These steps may be repeated after a predetermined period of time has passed (e.g. once per hour), and for a predetermined duration (e.g. days, weeks, months or years). In this way, a temporal record of the geolocation of the participant device may be generated and stored on the remote server and used to predict future geolocations of the participant device (and thus the participant) for facilitating successful transactions, such as the delivery of mail or goods. In yet another embodiment, the application may be configured to poll the participant mobile device for geolocation data at a specific time of day over the course of one or more days.

A remote server or managing computer system according to embodiments of the present disclosure may be programmed to receive participant identification data, address data, the telephone number, geolocation data and associated date and time data generated by the participant device. Once received, this data may be processed, which may include the steps including identifying, classifying and storing the received data. For example, any standardized or non-standard address data may be identified and classified accordingly. Geolocation data may also be identified. This may include identifying the format in which the geolocation data has been transmitted/received, and classified accordingly. Specifically, it is envisioned that geolocation data received from participant devices may take on differing or non-standardized forms (e.g. not in the form of conventional latitude and longitude coordinates). Accordingly, received and identified geolocation data may be normalized, or converted, to any suitable standard format. Normalized geolocation data may be stored in one or more databases, along with the received participant identification data, date and time data, and any associated address data. This data may be used to create a geographical information database according to embodiments of the present disclosure.

In addition to participant identification data and associated geolocation data, it is envisioned that the geographical information database may incorporate additional forms of data. For example, general geographical data (e.g. map data) and infrastructure data, including existing data relating to geographical boundaries of countries and associated states, cities, towns, monuments, roadways, and the like may be imported into the database. This information may be sourced from existing compiled data sources and may provide a foundation for building a database according to an embodiment of the present disclosure. Preexisting data relating to individuals, entities, and the like, and their associated addresses may also be imported. For example, this data may include information from existing geographical information databases containing geolocation data derived from standardized addresses. In this way, databases according to embodiments of the present disclosure are not limited to geolocation data sourced from the methods described herein, but rather, geolocation data derived from any means, including standard geocoding.

A geographical information database according to embodiments of the present disclosure may be accessed by authorized parties for the purpose of providing predicted or estimated geolocations of one or more identified individuals or entities. In one embodiment, the managing computer system may receive a request for geolocation data associated with an identified individual from an authorized party. By way of example, one or more postal services may request geolocation data associated with an individual designated to receive a package or piece of mail. This request for geolocation data may be further classified according to one or more characteristics of the request (e.g. temporal or geographical characteristics). For example, an individual may have made an online purchase of a good and provided shipping address information to a merchant, including non-standardized address data (e.g. “above the Laundromat”). Accordingly, the received request for geolocation information may include the identification of the non-standardized address description provided by the individual. The request may also include an expected date or time of delivery.

From this request, the managing computer system may access the geographical information database and identify relevant historical geolocation data associated with the individual. Once geolocation data has been identified, historic and/or comparative analysis may be performed in order to generate a predicted or expected geolocation of the individual (or of the individual's mobile computing device). For example, if the request includes an expected date and/or time of delivery, the managing computer system may perform a historical analysis of the identified data to generate a predicted geolocation of the individual at or around the estimated time of delivery. By way of example, if the package is estimated to be delivered on a Tuesday at noon, a historical analysis may be performed, identifying the most probable geolocation of the individual's device on Tuesdays (or on other weekdays) at the estimate time. In this way, the logic may provide a predictive function. Likewise, if the request includes a non-standardized address description (e.g. “above the Laundromat”), the managing computer system may analyze the geolocation data in an attempt to identify a geolocation that has previously been associated with this non-standardized address description. The managing computer system may output the results of these logic operations in the form of a predicted or expected geolocation of the individual's device. In still other embodiments, one or more external computer systems and/or the managing computer system described herein may be configured to provide the predicted or expected geolocation and associated information regarding, for example, a scheduled delivery time to an individual. This transmission may take the form of, for example, a query provided via a personal communication device of the individual, requesting confirmation that the individual will be located at the predicted or expected geolocation on an estimated delivery date and/or an estimated delivery time window on an estimated delivery date. Moreover, the query may be used to request confirmation from the individual that the individual desires and/or consents for an item to be delivered to that location. The reply from the individual, such as a confirmation that the individual will be located at a given geolocation on the estimated delivery date, within a time window on the estimated delivery date, and approval or consent for delivery to the individual at the location, may be provided by the managing computer system in response to the request.

It should also be understood that databases according to embodiments of the present disclosure may also provide for the ability to instruct shipments or mail to be delivered “to a phone number”. For example, a request for a geolocation may be made simply by identifying the phone number of an individual. The managing computer may return a predominant geolocation associated with the phone number. The returned geolocation may be a geolocation most frequently associated with the phone number over a time period, a geolocation most frequently associated with the phone number during times of day when delivery services are operating. Moreover, as telephone providers are able to access the location of mobile phones connected to their network, these networks may be implemented to perform geolocation queries, identifying the location of one or more participant devices at or around a specific expected time of delivery.

Alternative embodiments of the present disclosure include systems and devices having the ability to perform reverse geolocation operations at the request of a participant. Reverse geolocation generally includes estimating a standardized address from geographical coordinates or geolocations. In this way, a participant may request, for example, via a user-selectable option displayed on an interface generated by the software application running on their mobile device, an estimated standardized address of their current location. Upon user request, the mobile device may transmit its geolocation to the managing computer system. The managing computer may access the geographical information database, and attempt to determine a standardized address associated with the geolocation provided. In some embodiments, this may include returning the standardized address of, for example, a building or residence, nearest to the geolocation provided by the participant's mobile device.

While embodiments of the present disclosure have been described herein as utilizing GPS data received from a personal computing device (e.g. a mobile phone), it should be understood that embodiments of the present disclosure may utilize other methods to calculate the location of a device of a user. For example, triangulation or multilateration of radio signals between multiple radio towers of a phone network, GSM localization, or any other suitable methods may be used. Moreover, locations of internet-accessible mobile devices may be determined via analysis of IP addresses associated with the device.

While many of the above processing operations have been described as being performed by a remote server or managing computer system, it should be understood that some or all of these processes may be performed on the participant's computing device, and the results of the processing transmitted to the managing computer system for storage and future access. Moreover, data transmissions between the participant device(s) and the managing computer system may be initiated by the participant device or may be initiated by request originating from the managing computer system.

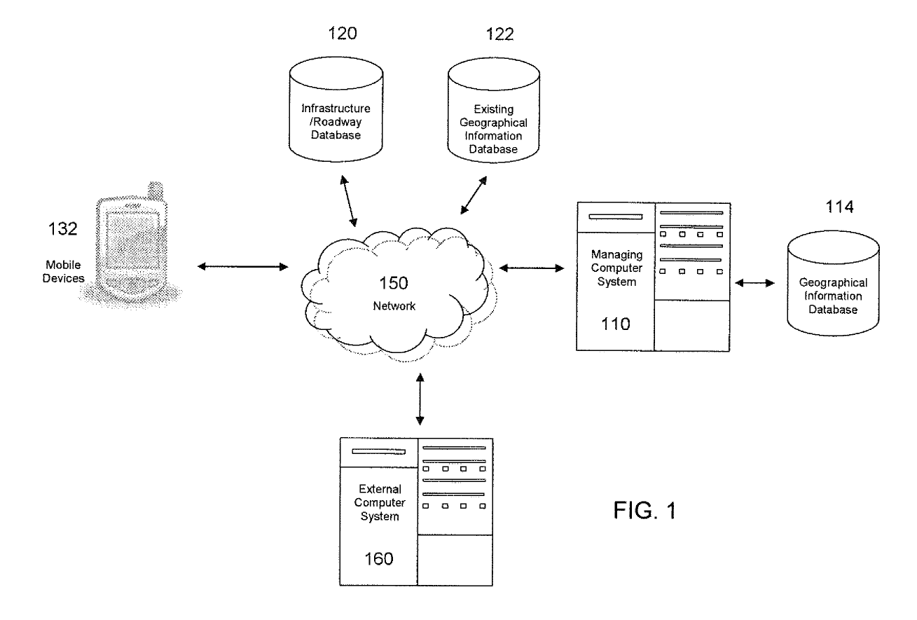

Referring now to FIG. 1, there is shown a high-level diagram illustrating an exemplary system for generating one or more geographical information databases 114 associating participants with one or more geolocations, including those participants located in areas lacking standardized addresses. As shown in FIG. 1, system 100 includes a remote server embodied as a managing computer system 110. Managing computer system 110 may receive data from at least one source, including one or more participant mobile devices 132 (e.g. a mobile phone), an existing infrastructure database 120, and an existing geographical information database 122.

In one embodiment, a participant may download a software-based application to their mobile device 132 through any conventional means. For example, a participant may access a web-based application stored on managing computer system 110 or another remote server via mobile device 132. The web-based application may include executable instructions for downloading an application according to embodiments of the present disclosure onto mobile device 132. Once downloaded and installed, the application may cause the mobile device to generate and display a user interface including a prompt a participant to enter identification information, such as their first and last name. The application user interface may also prompt the participant to enter address information. The prompt may include fields for standardized address information (e.g. postal code, city, street etc.) or non-standardized descriptive address information, or combinations thereof. The application may include in one or more user interface screens prompts and fields to permit the entry of information relating to multiple addresses. For example, the user interface may include prompts for a participant to enter address information for their place of residence, as well as their place of work, and may identify each address as such. Information entered by the participant, as well as the date and time at which they were entered, may be stored within a memory of mobile device 132. The application may access a phone number associated with the mobile device, or may include prompts and fields on a user interface screen for participant to input a phone number associated with their mobile device 132. In one embodiment, the application may prompt the user to characterize their current location, such as at a workplace, a residence, a restaurant, etc.) The user interface may be configured to prompt for other information useful to associate the participant with a purchase transaction and hence a package delivery. Such other information may include, by way of example, payment card numbers, government-issued identification numbers, such as driver license, passport or other identification card numbers. An answer may be stored into memory and associated with any geolocation calculations performed at or around the time of entry.

The application is further configured to generate geolocation data based on the position of the participant's mobile device 132. In one embodiment, this step may include interfacing with the mobile device's on-board GPS system for determining the geolocation of mobile device 132. The step of generating geolocation data may be done automatically after entry to the above-described participant data, or done in response to a participant input. In this way, a participant may enter their identification data and their address data while they are not located at the input address, and initiate a geolocation determining step at a later time when they are present at the input location. In one embodiment, the date and time of the generation of geolocation information may also be captured and stored into the memory of mobile device 132.

Automatically, or upon a participant command, the application may be configured to transmit the generated geolocation data, participant identification data, address data (if available) and date and time data associated with at least one of the input of the participant information or the generation of geolocation data to managing computer system 110 via, for example the network 150 accessible through a wireless data connection of participant mobile device 132 (e.g. a cellular phone data network). The network 150 can be virtually any form or mixture of networks consistent with embodiments as described herein include, but are not limited to, telecommunication or telephone lines, the Internet, an intranet, a local area network (LAN), a wide area network (WAN), virtual private network (VPN) and/or a wireless connection using radio frequency (RF) and/or infrared (IR) transmission to name a few.

Embodiments of the present disclosure may periodically transmit updated geolocation data associated with the participant mobile device 132, as well as a date and time of the geolocation generation. In one embodiment, the application may await the passage of a predetermined time period (e.g. one hour), and may repeat the steps of generating geolocation data and an associated date and time of the generation, as well as the transmission of said data to managing computer system 110. Managing computer system 110 may store the geolocation and time and date data, for numerous times and dates, for the mobile device. Managing computer system 110 may use the stored data, using pattern-identifying logic, for example, to generate predictions of the location of the participant's mobile device 132 at specified future dates and times.

Managing computer system 110 may be programmed to receive participant identification data, address data, associate date and time data, as well as geolocation data generated by participant mobile device 132. Once received, this data may be processed by managing computer system 110, including the steps of identifying, classifying and storing the received data. For example, any standardized or non-standard address data contained in the address data may be identified and classified accordingly. Natural language processing may be employed to standardize text-based descriptions of locations, such as by correcting spelling and other standardization techniques. Geolocation data may also be identified. This may include identifying the format in which the geolocation data has been transmitted/received, and classified accordingly. Received and identified geolocation data may be normalized to any suitable predetermined standard format. Managing computer system 110 may use the normalized geolocation data, participant identification data, phone number data, date and time data, and any associated address data may be used to create a geographical information database 114 according to an embodiment of the present disclosure.

Geographical information database 114 may incorporate additional forms of data. For example, general geographical data (e.g. map data) and infrastructure data, including existing data relating to geographical boundaries of countries and associated states, cities, towns, monuments, roadways, and the like may be imported into database 114 by managing computer system 110. This information may be sourced from existing compiled data sources embodied herein as infrastructure database 120 and geographical information database 122. Preexisting data relating to individuals, entities, and the like, and their associated addresses may also be imported. For example, this data may include information from existing geographical information database containing geolocation data derived from standardized addresses. In this way, database 114 may include geolocation data derived from any technique, such as standard geocoding. As will be set forth in greater detail herein, geographical information database 114 may be accessed and analyzed by managing computer system 110 in order to respond to requests for geolocation information from outside systems, for example, a computer system of a postal or delivery service, embodied herein as external computer system(s) 160.

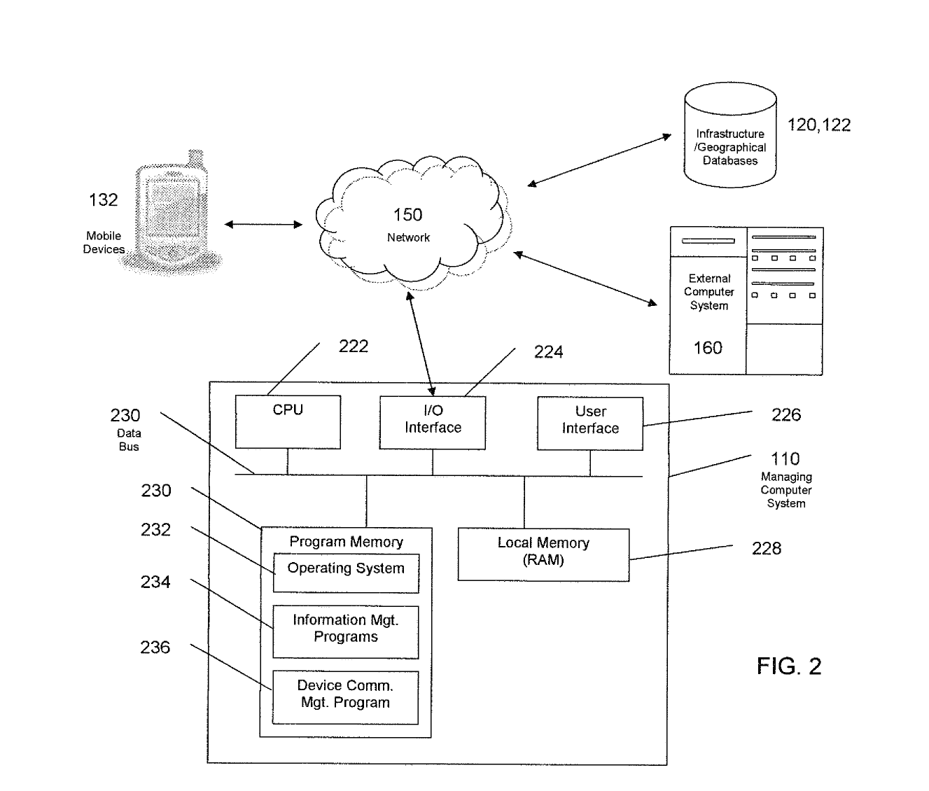

Referring now to FIG. 2, a more detailed embodiment of an exemplary managing computer system 110 as described above with respect to FIG. 1 is shown. Managing computer system 110 includes a data bus 220 providing communication among system components. One or more computer processors, designated by central processing unit (CPU) 222, is in communication via data bus 220 with components including program memory 230, local memory 228, user interface 226, and input/output interface 224. Program memory 230 stores programs including an operating system (OS) 232, which manages the computer hardware and provides common services for efficient execution of various logic circuitry including hardware, software and/or programs. Program memory 230 further stores one or more programs 234, which include computer-executable instructions to execute rules to perform the processing described herein, such as the identification and classification of received data, the normalization of geolocation data, the generation of a geographical information database 114 (FIG. 1), as well as the control of communications between the managing computer system 110 and other external devices or databases. Managing computer system 110 further includes device communication management program 236, which includes computer-executable instructions to manage communications, including communications of data to and from participant mobile devices 132 and external systems 160. The processor 222 (or CPU) carries out the instructions of computer programs, which operates and/or controls at least a portion of the functionality of the managing computer system 110. Program instructions may be loaded into local memory 228 for efficient and high-speed execution by CPU 222. Programs may be arranged in one or more modules, and functionality of programs may be implemented in program code that may be arranged as one or more programs or modules, which need not be stored on a same memory device, or executed by a single CPU.

Managing computer system 110 further includes device input/output interface 224 configured to receive and output data and information to and/or from managing computer system 110 from and/or to peripheral devices and networks operatively coupled to the system. Such networks may include exemplary internet network 150, which manages communications among, for example, external databases 120, 122, external computer systems 160, and participant device(s) 132. The I/O interface 224 may include a query interface configured to accept and parse requests from participant mobile devices 132 and external systems 160, and pass those requests to CPU 222 for processing using instructions of device communication management program 236.

Program memory 230 may include one or more of any form of data storage device including but not limited to electronic, magnetic, optical recording mechanisms, combinations thereof or any other form of memory device capable of storing data. The CPU 222 may be in the form of one or more computer processors, or may be in such forms as a distributed computing system, a centralized computing system, a network server with communication modules and other processors, or nearly any other automated information processing system capable of executing instructions stored in program memory. Managing computer system 110 may be embodied as a data warehouse or repository for storing, managing and processing volumes geographic data received from a variety of sources on a periodic or continuous basis.

Each or any combination of the modules and components shown in FIGS. 1 and 2 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure.

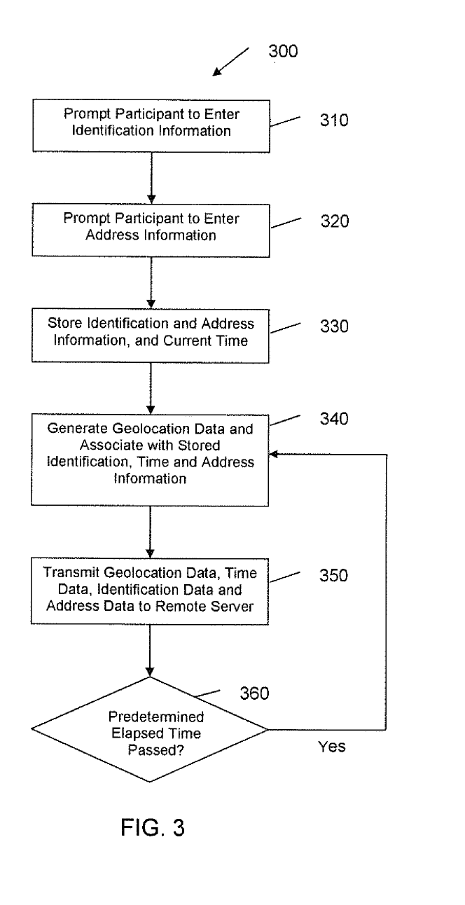

Referring now to FIG. 3, an exemplary process flow diagram is shown of a method 300 for gathering participant geolocation data using, for example, geolocation information obtained from a personal computing device, such as a GPS-equipped mobile phone. An application running on a participant mobile device is configured to generate a display interface to prompt 310 a participant to enter identification information, such as their first and last name, and the phone number of the mobile device. The application may also prompt 320, via a same display interface or separate screens or displays, the participant to enter any available address information. The interface may include fields to permit entry of both standardized and non-standardized address information. Information entered by the participant is received and stored 330 by the participant mobile device. The application is further configured to generate 340 geolocation data based on the position of the participant mobile device. In one embodiment, this step may include interfacing with the device's on-board GPS system and determining the geolocation of the device. The step of generating geolocation data may be done automatically after entry of the above-described participant data, or done in response to a participant input command. In one embodiment, the date and time of the generation of geolocation information may be stored into the memory of the participant mobile device.

Automatically, or in response to a participant command, the participant mobile device may, executing instructions of the application, transmit 350 the generated geolocation data, participant identification data, device phone number, address data (if available) and date and time data to a remote server or managing computer via, for example, a wireless network such as a cellular phone data network or a wifi network. As set forth above, embodiments of the present disclosure may periodically transmit updated geolocation data associated with the participant mobile device, as well as the date and time of the updates. In one embodiment, the application may await the passage of a predetermined time period 360, and may repeat the steps of generating 340 geolocation data and associated date and time of the generation, as well as the transmission 350 of said data to the managing computer system.

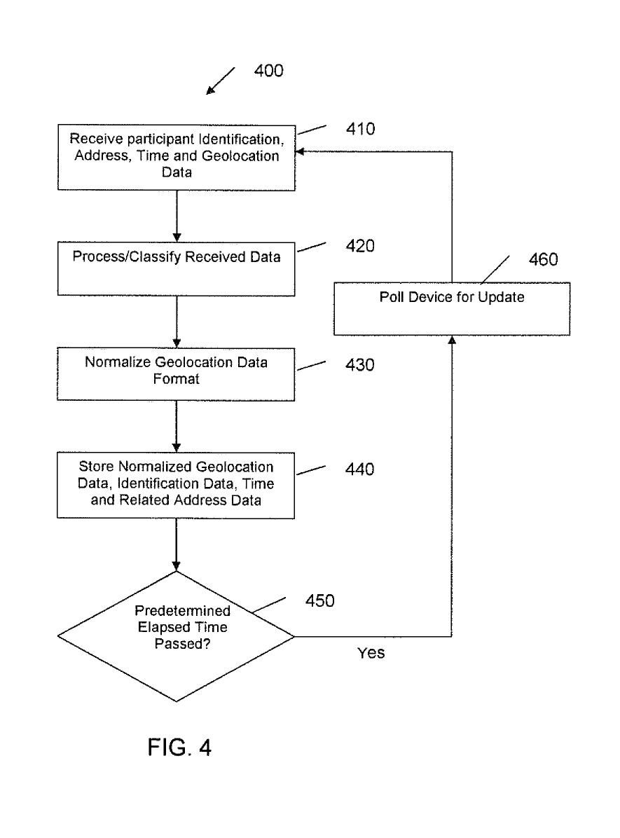

Referring generally to FIG. 4, an exemplary process flow diagram is shown of a method 400 for receiving and storing geolocation data received from participant mobile devices on a remote server or managing computer system according to an embodiment of the present disclosure. A remote server or managing computer system (e.g. managing computer system 110 of FIG. 1) may be programmed to receive 410 participant identification data, address data, phone number data, associated date and time data, as well as geolocation data generated by the participant mobile devices. Once received, this data may be processed 420, which may include the steps including identifying, classifying and storing the received data. For example, any standardized or non-standard address data contained in the address data may be identified and classified accordingly. Geolocation data may be identified, including identifying the format in which it has been transmitted/received and classified accordingly. All of the data may be associated with the participant identification data (e.g. the participant's name) and stored in a memory of the managing computer system.

Received and identified geolocation data may be normalized 430 or converted to any suitable standard format. Normalized geolocation data may be stored 440 (e.g. in one or more databases) along with the received participant identification data, date and time data, phone number data, and any associated address data. While the embodiment of FIG. 3 describes a periodic geolocation update initiated by the participant device, it is envisioned that these periodic updates 450 may be initiated by the remote server or managing computer system. For example, after the passage of a predetermined time, the managing computer system may poll 460 the participant mobile device for updated geolocation data. Once received 410, the steps of processing 420, normalizing 430, and storing 440 may be repeated. In one embodiment, this periodic polling may be performed indefinitely, without any additional input by the participant, such that a continuous historic record of a participant mobile device's geolocation is generated.

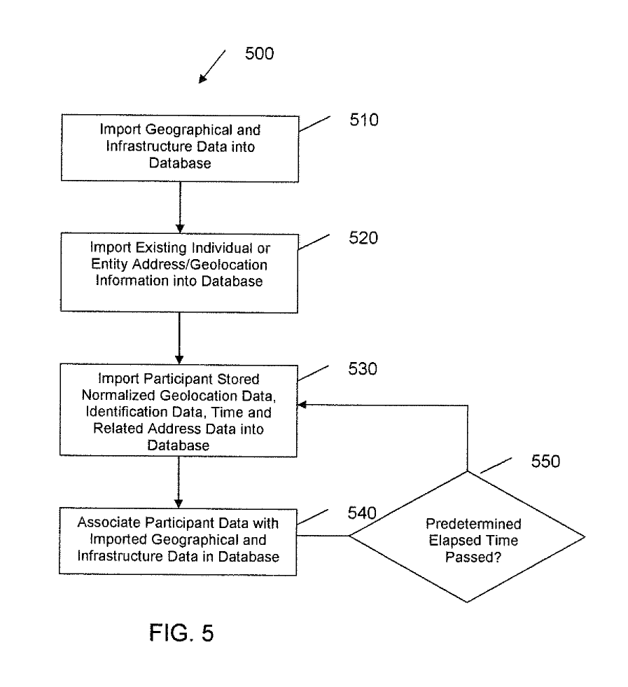

Referring generally to FIG. 5, an exemplary process flow diagram is shown of a method 500 for creating and populating a geographical information database comprising geolocation data associated with one or more individuals or entities. Geographical data or map data and infrastructure data, including existing data relating to geographical boundaries of countries and associated states, cities, towns, monuments, roadways, and the like may be imported 510 into the geographical information database. This information may be sourced from existing compiled data sources and may provide a foundation for building a database according to an embodiment of the present disclosure. Existing data relating to individuals, entities, or locations, and their associated addresses may also be imported 520. For example, this existing data may comprise data imported from existing geographical information systems that has been previously geolocated from standardized addresses. Participant data, such as that derived through the methods set forth in FIGS. 3 and 4, may also be imported 530 into the database. Geolocation data from participant mobile devices may be associated 540 with the previously imported geographical data. As with other embodiments of the present disclosure, the geographical information database may be updated 550 periodically, which may include performance of any or all of the steps 510, 520, 540, 550.

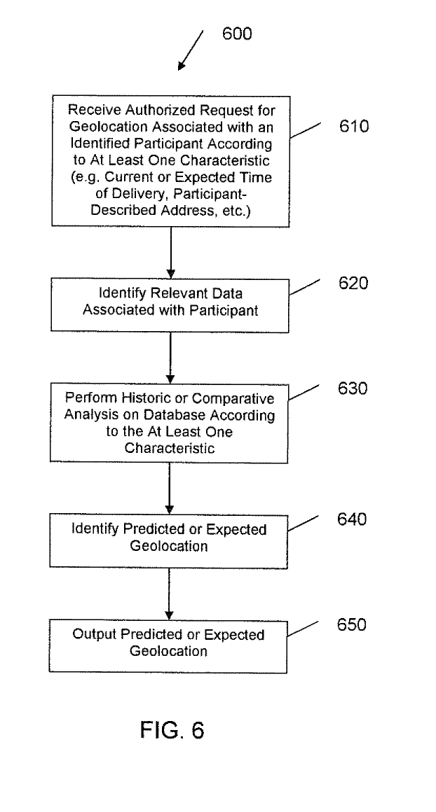

Referring generally to FIG. 6, an exemplary process flow diagram is shown of a method 600 for utilizing data compiled within a geographical information database according to an embodiment of the present disclosure to facilitate, for example, the delivery of a good to a participant. A request from an authorized party for a geolocation of an identified participant is received 610. For example, a computer system of one or more postal services or other delivery services may request geolocation data associated with a participant designated to receive a package or piece of mail in their possession. This request for geolocation data may be accompanied by further information used to characterize an aspect of the transaction. In one instance, a participant may have provided delivery or shipping address information to a merchant, including, for example, non-standardized address data such as descriptive terms the participant used to identify their desired shipping location. In embodiments, the request may include information provided by or associated with the participant, such as a mobile telephone number, a payment card number, a government issued identification number, or other data. In embodiments, the request may include one or more times and dates of delivery, or time intervals and dates of delivery. In embodiments, the request may be in the form of an xml format message or other format message, including fields corresponding to each available item of information.

Responsive to receipt of this request, the remote server may query the database to identify a matching participant. Upon identification of a matching participant, the system may identify 620 relevant historical geolocation data associated with the participant. In embodiments, responsive to the request, data associated may be analyzed, using suitable predictive algorithms, if the request includes an estimated or expected date and/or time of delivery, for identifying 640 the most probable geolocation of the participant device on the estimated delivery date and time. In other embodiments, analysis of data may be performed periodically to determine likely locations at particular times of day, days of the week, months of the year, and the like, and stored in association in participant identifying information. Likewise, if the request specifies that the package is to be delivered to the participant's non-standardized address description, the remote server may analyze the stored data in an attempt to identify a geolocation that has been previously-associated with this non-standardized address description. The managing computer system may output 650 the results of these logic operations in the form of a predicted or expected geolocation of the participant device to facilitate delivery of the package or mail. The output data may be provided via xml format message or other suitably formatted message in response to the request, thereby providing geolocation data to a third party delivery service computer system for incorporation in delivery instructions. As described above, a third party computer system or the managing computer system described herein may be configured to query an intended recipient of a package (e.g. via a personal communication device), to confirm that the recipient will be located at the predicted or expected geolocation on the estimated delivery date and/or within a time window on the estimated delivery date. Moreover, the query may request confirmation that the recipient wishes and/or consents for an item to be delivered to that location. The reply from the recipient, such as a confirmation that the recipient will be located at a given geolocation on the estimated delivery date, within a time window on the estimated delivery date, and approval or consent for delivery to the recipient at the location, may be provided by the managing computer system in response to the request.

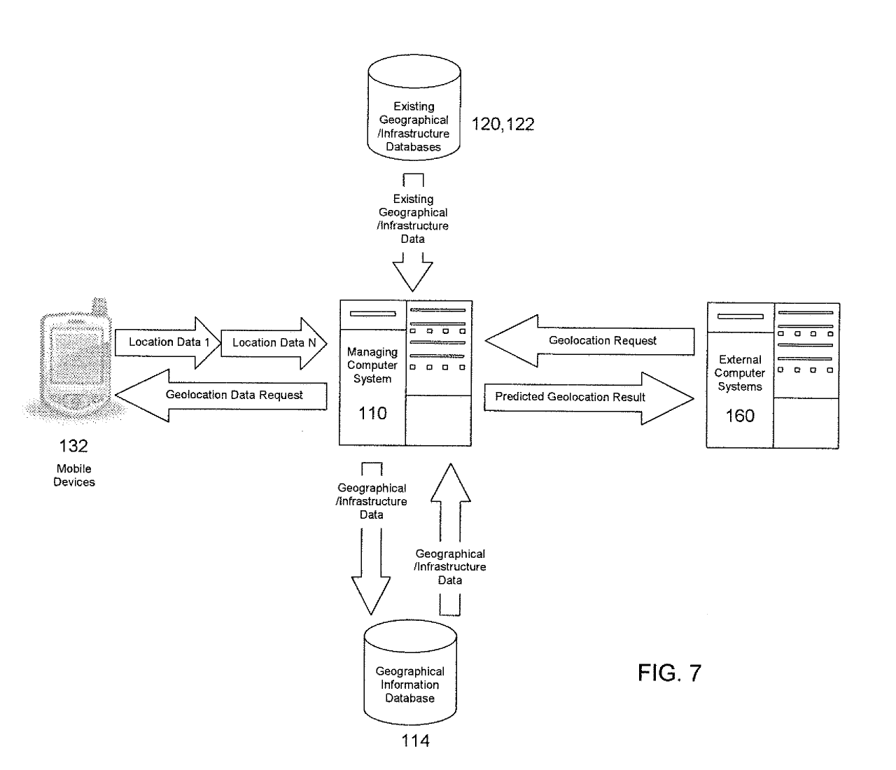

FIG. 7 illustrates a data flow diagram for determining a predicted or expected geolocation of an identified participant according to an embodiment of the present disclosure. Managing computer system 110 may receive data from at least one source, including one or more participant mobile devices 132 (e.g. a mobile phone), an existing infrastructure database 120, and an existing geographical information database 122. More specifically, mobile device 132 may be configured to transmit the generated geolocation data, participant identification data, address data (if available) and date and time data associated with at least one of the input of the participant information or the generation of geolocation data to managing computer system 110. Embodiments of the present disclosure may include periodic transmittal of updated geolocation data associated with the participant mobile device 132, as well as a date and time of the geolocation generation. In this way, a plurality of geolocations, embodied herein as Location Data 1-N, may be transmitted to managing computer system 110.

Managing computer system 110 may be programmed to receive participant identification data, address data, associated date and time data, as well as geolocation data generated by participant mobile device 132. Once received, this data may be processed by managing computer system 110, as described in detail above, and used to populate a geographical information database 114 according to an embodiment of the present disclosure. Geographical information database 114 may incorporate additional forms of data. For example, general geographical data and infrastructure data, including existing data relating to geographical boundaries of countries and associated states, cities, towns, monuments, roadways, and the like may be imported into database 114 via managing computer system 110. This information may be sourced from existing compiled data sources embodied herein as infrastructure database 120 and geographical information database 122.

Geographical information database 114 may be accessed and analyzed by managing computer system 110 in order to respond to requests for geolocation information from outside systems, for example, a computer system of a postal or delivery service, embodied herein as external computer system(s) 160. A predicted or estimated geolocation resulting from the request may be transmitted back to external computer system(s) 160, and/or to an individual associated with the geolocation for confirmation of the accuracy of the predicted geolocation.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, each of the steps of the methods described with reference to FIGS. 3-6 may be performed by an applications processing unit (APU), which may include one or more processors. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

What is claimed is:

1. A system for gathering geolocation data from a personal computing device, the system comprising:
one or more computer processors;
a memory in communication with the one or more processors and storing program instructions, the one or more computer processors operative with the program instructions to:
generate a user interface on a display including one or more prompts for user identification data;
receive user identification data entered into the personal computing device;
determine a geolocation of the personal computing device;
determine date and time data associated with the determination of the geolocation of the personal computing device; and
transmit to a remote server the user identification data, the geolocation, and the date and time data.

2. The system of claim 1, wherein the one or more computer processors is operative with the program instructions to:
include in the user interface one or more prompts for address description data;
receive address description data entered into the personal computing device; and
transmit to the remote server the address description data.

3. The system of claim 1, wherein the one or more processors is operative with the program instructions to repeat the steps of determining the geolocation of the personal computing device, determining the date and time data associated with the determination of the geolocation, and transmitting the geolocation and date and time data at a predetermined interval.

4. A computer-implemented method for gathering geolocation data from a personal computing device, the method comprising:
generating, by one or more computer processors of the personal computing device, a user interface prompting for input of user identification data and address description data on a display of the personal computing device;
receiving, by the one or more computer processors, via the user interface, user identification data entered into the personal computing device;
receiving, by the one or more computer processors, via the user interface, address description data entered into the personal computing device;
determining, by the one or more computer processors, the geolocation of the personal computing device;
determining, by the one or more computer processors, date and time data associated with the determination of the geolocation of the personal computing device;
transmitting via a wireless network to a remote server the user identification and address description data, the geolocation and the date and time data associated with the geolocation determination.

5. The method of claim 4, further comprising the step of repeating the steps of determining the geolocation of the personal computing device, determining the date and time data, and transmitting the geolocation and date and time data at a predetermined interval.

6. A computer system for predicting the geolocation of an individual in response to a request, the system comprising:
one or more computer processors;
a memory in communication with the one or more computer processors and storing program instructions, the one or more computer processors operative with the program instructions to:
receive a request for geolocation data associated with a personal computing device of an identified individual according to at least one temporal or geographical characteristic;
identifying geolocation data associated with the personal computing device of the identified individual in a database comprising data associating the geolocations of a plurality of personal computing devices of a plurality of individuals;
analyzing the identified data according to the at least one characteristic; and
generating an expected geolocation of the individual based on the analysis.

7. The system of claim 6, wherein the at least one characteristic is an estimated future time or date, and the step of analyzing the identified data includes performing a historical analysis of the identified data for predicting the geolocation of the individual at or around the estimated future time or date.

8. The system of claim 6, wherein the at least one characteristic is a non-standardized address description, and the step of analyzing the identified data includes performing a comparative analysis to identify a geolocation associated with the non-standardized address description.

9. The system of claim 6, wherein the one or more processors is operative with the program instructions to transmit the expected geolocation to the individual.

10. A computer-implemented method for predicting the geolocation of an individual in response to a request, the method comprising:
receiving, by one or more computer processors over a network, data indicative of a request for geolocation data associated with a personal computing device of an identified individual according to at least one characteristic;
identifying, by the one or more computer processors, geolocation data associated with the personal computing device of the identified individual in a database comprising data associating the geolocations of a plurality of personal computing devices of a plurality of individuals;
analyzing, by the one or more computer processors, the identified data according to the at least one characteristic; and
predicting, by the one or more computer processors an expected geolocation of the individual based on the analysis.

11. The method of claim 10, wherein the at least one characteristic is an estimated future time or date, and the step of analyzing the identified data includes performing a historical analysis of the identified data for predicting the geolocation of the individual at or around the estimated future time or date.

12. The method of claim 10, wherein the at least one characteristic is a non-standardized address description, and the step of analyzing the identified data includes performing a comparative analysis to identify a geolocation associated with the non-standardized address description.

13. A computer-implemented method for generating a geographical information database associating personal computing device users with one or more geolocations, the method comprising:
receiving, by one or more computer processors, from a personal computing device user identification data, geolocation data corresponding to a location of the personal computing device, and date and time data associated with the geolocation data;
storing the user identification data, the geolocation data, and the date and time data in a database in one or more data storage devices; and
repeating, by the one or more computer processors, the steps of receiving and storing for a plurality of personal computing device of a plurality of users.

14. The method of claim 13, further comprising the step of periodically requesting updated geolocation data, and date and time data associated with the updated geolocation data from the personal computing device of the user.

15. The method of claim 13, further comprising the step of normalizing the received geolocation data into a standard format.
